(19) United States
(12) Patent Application Publication
(10) Pub. No.: US 2012/0132779 A1
(43) Pub. Date: May 31, 2012

(54) Umbrella holder system for docks and decks

(76) Inventors: Amber Melan Johnson, Kelowna (CA); Brenda V. Parkhill, Kelowna (CA)

(21) Appl. No.: 12/926,612

(22) Filed: Nov. 30, 2010

(51) Int. Cl. F16M 13/02; B23P 17/04

(52) U.S. Cl. 248/513; 29/428

(57) ABSTRACT

A system and method for supporting one or more umbrella poles on a sunning platform such as a dock or deck includes providing a plurality of pole supports and mounting the base of each pole support to the platform. Each base is mounted to the platform so that an upper-most surface of each base is flush with the platform and aligned vertically. The pole supports are mounted around the perimeter of the platform so as to be spaced apart along at least a side of the platform closest to the sun at a first pre-selected time of day. At each pre-selected time of day, an umbrella when fully open and mounted in a pre-positioned pole support produces a corresponding shadow which falls substantially completely on the platform. A pre-selected sequence of positions provides shade on the platform at desired times of day.

### FIELD OF THE INVENTION

This invention relates to the field of devices for supporting dock and deck umbrellas and in particular to a system and method for unobtrusively supporting umbrella poles such that, at any particular time of the day, an area of useable shade is provided on the dock or deck.

### BACKGROUND OF THE INVENTION

Users enjoying relaxation on a sunny day on their dock or deck will often seek shade in order to avoid uncomfortable overheating or sunburn. Consequently, it is well known in the prior art to provide sun shading umbrellas which have a single centrally disposed pole on which is mounted a collapsible and generally circular shaped collapsible fabric sun-shade. The fabric of the sun-shade is typically mounted on to a radially spaced apart array of rigid spokes, each of which pivotally mounted at the vertex of the sun-shade coinciding with the top of the pole. A corresponding radially spaced apart array of rigid linear braces extend from the spokes, where they are positioned generally midway along the length of the spokes, to a slidable collar slidably mounted onto the umbrella pole, for translation therealong. When the collar is slid upwardly along the pole, the braces are driven radially outwardly of the pole, carrying with them the spokes. The spokes, being constrained by their mounting to the top of the pole, spread radially outwardly so as to open the sun-shade into a generally flattened conical form which provides a penumbra of shade underneath the sun-shade. The position of the penumbra of shade is determined by the position of the sun relative to the sun-shade.

In order to maximize the size of the penumbra of shade under the sun-shade, the diameter of the sun-shade when fully opened is relatively large, often in the order of four or more feet in diameter. Consequently, in the presence of wind gusts, which, in the case of docks in particular, will often occur during the afternoon due to the effects of the sun on the local air temperature, steps must be taken to either reduce the parachute-effect of the open sun-shade or to very securely anchor the bottom of the pole, or both. Thus a user enjoying the dock or deck may be forced to lower the sun-shade into its fully closed position when the wind gusts. In order to resists the effects of the wind gusts the base of the umbrella is conventionally supported in a relatively heavy base structure. Such a base may conventionally be a hollow container filled with sand or water, where the bottom of the pole is supported in the top of the container, or, for example, may be a heavy metal base supporting a vertically upstanding cylindrical metal collar in to which the bottom of the pole is snugly fit.

It has been applicant's experience that such conventional base supports for umbrella poles will usually successfully support a closed umbrella during night wind gusts, but that during strong wind gusts the umbrella may have to be lifted entirely out of the base support and laid flat on the dock or deck. Conventional base supports also present other disadvantages. As already mentioned, unless the user is willing to risk the umbrella, when in its open position, being caught in a wind gust and either knocked over or picked up and carried from the dock or deck, the presence of wind gusts require that the sun-shade of the umbrella be closed, even if the umbrella pole is rigidly supported in a conventional heavy base support. However, the use of a conventional heavy base support makes it inconvenient and sometimes difficult, depending on the strength of the user, to adjust the position of the umbrella on the dock or deck. Further, for example in the case of conventional metal base supports, the dragging of the base support from one position to another, so as to position the umbrella so that the shade penumbra is in a convenient location, may cause damage to the surface of the dock or deck. Thus, often the heavy base support is positioned centrally on the dock or deck and is left essentially immobile so that the user changes his or her position in order to chase the position of the shade penumbra at any particular time of the day as the penumbra moves corresponding to the movement of the sun relative to the umbrella shade. Although at first blush, this may not seem to be much of a inconvenience to the user. In reality, because of the height of the umbrella shade above its base and therefore above the surface above the dock or deck, other than at times when the sun is substantially vertically positioned over the dock or deck, for example at high noon, the reality is that the shade penumbra often mostly or entirely is not covering a useful area of the dock or deck, being cast off to one side or the other of the dock or deck depending on the time of day. This is especially true for smaller or elongate narrow docks or decks that do not have a substantial floor space.

Thus there exists a need in the prior art, and is an object of the present invention to provide, a simple to use system and method whereby, at any particular time of the day, a plurality of non-obstructive pre-positioned umbrella base supports are provided either mounted in the dock or deck or, in a preferred embodiment, around the periphery the dock or deck so that a single umbrella or a small number of umbrellas may be placed into the base supports which correspond to the time of day at which shading from the sun is desired.

In the prior art, applicant is aware of other forms of umbrella base supports other than those already mentioned. In particular, applicant is aware of U.S. Pat. No. 6,003,826 which issued on Dec. 21, 1999 to Galloway for a Supporting System for Patio Deck Accessories, wherein Galloway describes an accessory for a patio deck having a floor and a peripheral railing where the accessory includes a stand to be fastened to the patio floor and a bracket to be fastened to the upper bar of the railing. The pole of an umbrella is mounted in a bore in the stand and through an aperture in the bracket.

Applicant is also aware of U.S. Design Pat. No. D469,342 which issued Jan. 28, 2003 for a Torch Holding Device which appears to applicant to disclose a torch in dotted outline which mounts down into a hollow tube. A mounting bracket appears to be mounted to the upper end the tube. Applicant is also aware of U.S. Pat. No. 6,708,703 which issued Mar. 23, 2004 to Rivers et al for a Portable Umbrella Pole Door Clip wherein Rivers et al teach an umbrella holder which may be secured to a cabinet and in particular where the umbrella holder engages a top portion of a cabinet door when the door is open, or alternatively where the umbrella holder may be wedged under a top edge of the cabinet, both so as to a position an umbrella pole when secured in the umbrella holder. The umbrella holder includes a cylinder through which is journalled an umbrella pole. The handle portion is mounted to the cylinder so as to support an arm from the handle portion. The handle portion and arm mount to the cabinet so as to support the cylinder vertically on the exterior thereof. A thumb screw is provided to secure the umbrella pole within the cylinder.

Applicant is also aware of U.S. Pat. No. 7,156,357 which issued Jan. 2, 2007, to Kocur for a Patio Umbrella Support Apparatus wherein Kocur describes a support apparatus which engages the mast of patio umbrella and which permits the positioning of the patio umbrella at desired selected positions on a patio deck when the patio deck is constructed of spaced apart deck planks. A vertical anchoring fin fits into the gap between adjacent deck planks. The fin is mounted to and depends downwardly from horizontal support flanges that ride on the top of the deck surface. The anchoring fin and horizontal flanges provide positional stability for the patio umbrella. A notch may be provided in the fin so that the fin may fit over cross members which extend underneath the deck planking.

### SUMMARY OF THE INVENTION

In summary the system and method for supporting one or more umbrella poles on a sunning platform such as a dock or deck includes in one aspect of the invention:
a) The step of providing a plurality of pole supports each having a base and a first sleeve, the first sleeve having opposite upper and lower ends, wherein the first sleeve is adapted for mounting a length of pole therein so that the length of pole extends between the upper and lower ends of the first sleeve, and wherein the lower end of the first sleeve is adapted for removable mounting in the base, and wherein a second sleeve may be provided which mounts nested into the first sleeve, and where the second sleeve is sized to snugly receive the base end of the umbrella pole therein.
b) The step of mounting the base of each pole support to the platform and where each base is adapted for mounting to the platform:
   i) so that an upper-most surface of each base is at or beneath an elevation of an upper surface of the platform and so that the first sleeve is substantially vertical when mounted to the base,
   ii) around at least a perimeter of the platform so as to be spaced apart in a spaced apart array of the supports along at least a first side of the platform closest to the sun at a first pre-selected time of day.

On a sunny day each umbrella when so mounted in a corresponding first and second sleeve casts a shadow on the platform when positioned on the platform. Each such shadow has orthogonally oriented first and second dimensions lying in a plane of the platform. When the sun is directly overhead of the platform the first and second dimensions are substantially equal. The first dimensions are substantially parallel to said first side of the platform. The spaced apart array of pole supports mounted along the first side of the platform are spaced apart by a first spacing which may in one embodiment be substantially equal to the first dimension at the pre-selected time of day. Thus at the first pre-selected time of day, a pair of substantially identical umbrellas when fully open and mounted in an adjacent pair of pole supports produce corresponding adjacent shadows which may: a) substantially cover the first spacing therebetween; and, b) fall substantially completely on the platform when the second dimension does not exceed a corresponding dimension of the platform.

Further pole supports may be mounted, and are adapted to be so mounted, along a second side of the platform closest to the sun at a second pre-selected time of day. At the second pre-selected time of day an umbrella when fully open and mounted in the at least one further pole support casts a shadow which falls substantially completely on the platform. The further pole supports may be mounted spaced apart along the second side of the platform so that adjacent substantially identical umbrellas when fully open and mounted thereto cast shadows which may:
a) substantially cover a corresponding spacing between adjacent pole supports of the plurality of further pole supports; and
b) fall substantially completely on the platform when the second dimension of the shadows does not exceed a corresponding dimension of the platform.

Collectively, the plurality of pole supports may be mounted spaced apart around a perimeter of the platform so that shadows cast by at least one umbrella, mounted in corresponding pole supports on a pre-selected side of the platform which is closest to the sun at a corresponding pre-selected time of day, fall substantially completely on the platform.

In a preferred embodiment the corresponding pre-selected times of day form part of a sequence of pre-selected times of day which correspond to a sequence of positions of the plurality of pole supports around the perimeter of the platform. Following the sequence of positions by mounting the at least one umbrella in positions in the sequence of positions according the corresponding sequence of pre-selected times of day results in the shadows of the umbrellas falling substantially completely on a corresponding portion of the platform, substantially throughout the sequence of pre-selected times of day, whereby at any one time of the pre-selected times of day at least one shadow falls on the platform to provide shade for a user on the platform.

In one embodiment each first or second sleeve includes a hollow, for example tubular, receiver having an open top end and an opposite bottom end, where the second sleeve receiver is sized to receive an umbrella pole journalled therein and wherein each base includes a mounting bracket to mount each base to a rigid surface for example on, in, or adjacent to the platform. The bases are mounted so as to position receivers vertically with the open top ends substantially directly above the bottom end. The bases are mounted to the platform at the sequence of positions.

Each base may mount to a corresponding bottom end of each of the first sleeve receivers in male/female mating engagement therebetween. Each first sleeve base may include a collar. Each receiver may be elongate and upstanding when mounted to the base, and sized to snugly mate down into the collar. Each first sleeve may be an outer sleeve and its receiver adapted to contain and support therein a corresponding length of the lower end of the second sleeve, and the receiver of the second or inner sleeve is adapted to contain and support therein a corresponding length of a lower end of an umbrella pole.

### BRIEF DESCRIPTION OF THE DRAWINGS

In the drawings wherein like reference numeral denote corresponding parts in each view:

FIG. 1 is, in front perspective view, the sleeve and base of a pole support according to one aspect of the present invention, wherein the sleeve in suspended over the base.

FIG. 2 is, in front perspective view, the assembled sleeve and base of FIG. 1 showing the base mounted to the side of a dock.

FIG. 3a is, in side elevation view, the outer or first sleeve of FIG. 1.

FIG. 3b is, in plan view, the outer sleeve of FIG. 3a.

FIG. 3c is, in side elevation view, the inner or second sleeve of FIG. 1.

FIG. 3d is, in plan view, the inner sleeve of FIG. 3c.

FIG. 4 is, in side elevation view, the base of FIG. 1.

FIG. 4a is, in plan view, the base of FIG. 4.

FIG. 5 is, in plan view, a dock representing various possible positions of the pole support of FIG. 1 and the corresponding shadows cast by umbrellas shown in dotted outline as a sunny day progresses as diagrammatically illustrated by the sun shown in three positions as it moves through an arc connecting those positions.

FIG. 6 is, in partially cut away perspective view, a portion of the dock of FIG. 5.

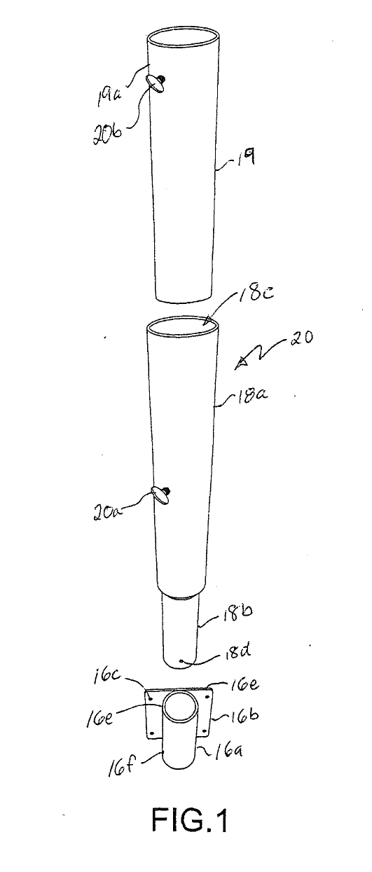

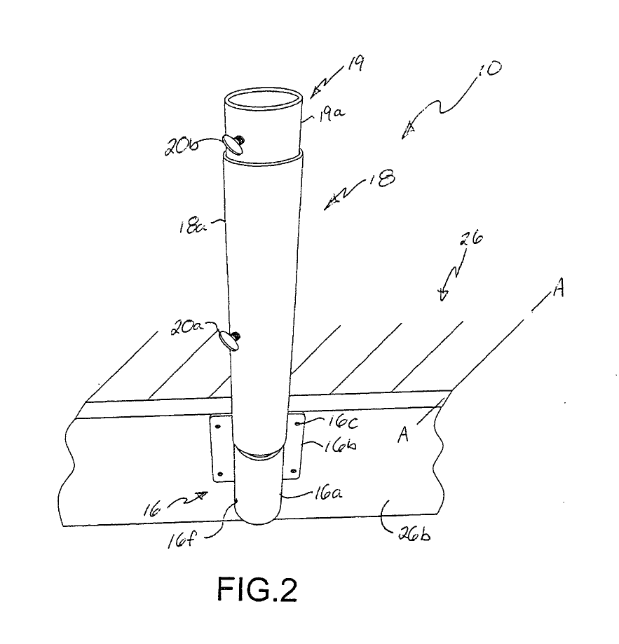

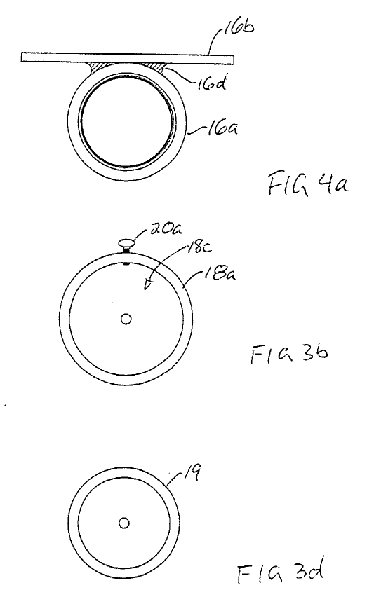

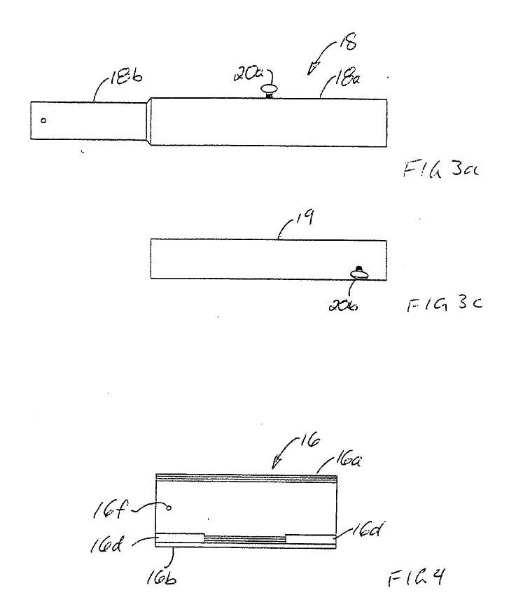

### DETAILED DESCRIPTION OF EMBODIMENTS OF THE INVENTION

In a preferred embodiment, each pole support 10 for supporting the pole 12 of an umbrella 14, includes a base 16 and an outer or first sleeve 18. Each base 16 includes a collar 16a mounted to a mounting bracket 16b. Mounting bracket 16b may be a flat plate as illustrated.

Outer sleeve 18 includes an upper receiver 18a and a lower male mating portion 18b sized for snug sliding mounting downwardly into collar 16a. Inner or second sleeve 19 is sized to snugly telescopically slide into outer sleeve 18 so as to extend down into outer sleeve 19 by substantially the entire elongate length of receiver 18a and so as to leave only a small upper band 19a at the top-most end of sleeve 19 exposed above receiver 18a. The use of inner sleeve 19 protects the base of exposed above receiver 18a. The use of inner sleeve 10 protects the base of pole 14, which is typically made of wood, from damage when the umbrella is repeatedly moved between based 16, as thumbscrews 20a grip against the metal of sleeve 10. Sleeve 10 also allows the telescopic adjustment of the height of the umbrella relative to its base 16, so as to allow adjustment of the position of it's shade.

Releasable fasteners are mounted to receiver 18a for releasably engaging sleeve 19 when journalled therein. Thumb-screws 20b are mounted in upper band 19a to releasably engage the lower most end of pole 12 when pole 12 is slid downwardly sleeve 19 and sleeve 19 down into receiver 18a. The thumb screws 20a and 20b are threadably mounted in corresponding threaded apertures in sleeves 18 and 19 respectively. Thumb screws 20a extend through the side wall of receiver 18a so that the inwardly disposed ends of thumb screws 20a protrude into the hollow cavity 18c of sleeve 18. Thus turning thumb screws 20a releases or tightens the frictional mounting of sleeve 19 into receiver 18. Similarly thumb screws 20b tighten onto or release pole 12 from sleeve 19. Umbrellas 14 may be conventional umbrellas having a conventional rigid pole 12 which, may be solid or hollow, and a conventional collapsible sun-shade 24 mounted thereon.

What follows is one type of platform on which the shade controlling system according to one aspect of the present invention may be mounted. Without intending to be limiting, the illustrated example is of a dock 26 of the type of which is conventionally built out over a body of water 28 and which is attached at one end to land 30. The present invention may be employed on other platforms such as other docks, or decks or other areas which are intended to be exposed to sun for the recreation of users who remain in a static position on the platform while sitting or lying in the sun for recreation. It is on platforms such as these that users will typically seek the cooler temperature resulting from not being directly exposed to sunlight and which is afforded by the user moving into the shade penumbra 32 or shadow cast by sun-shade 24.

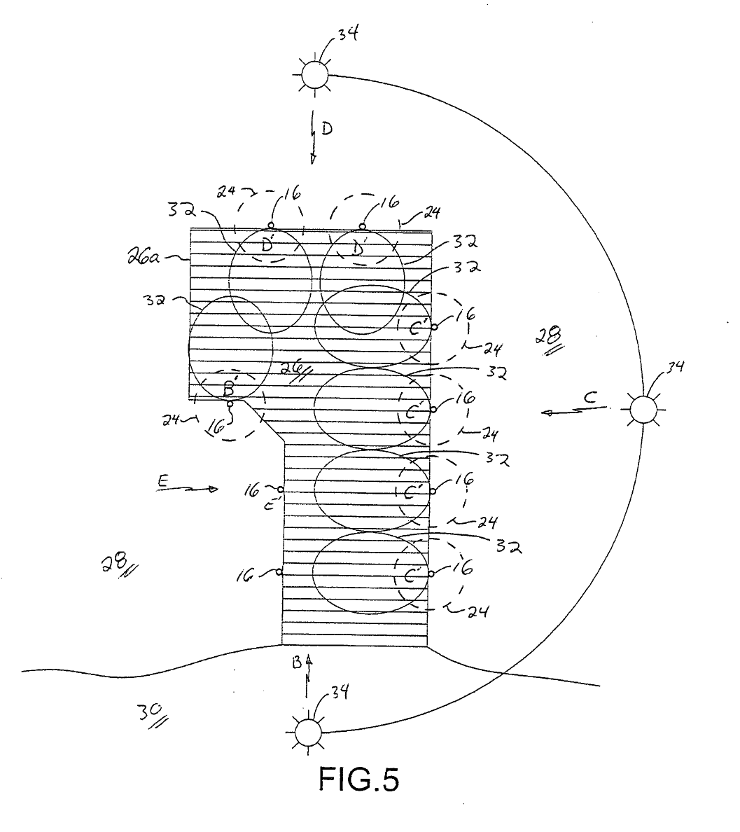

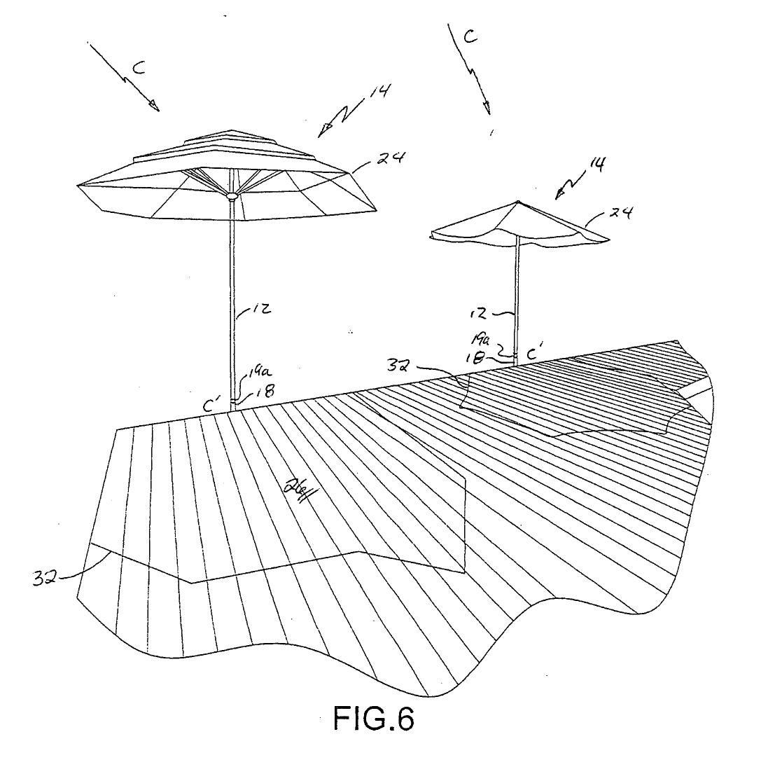

Thus in the example of FIG. 5, dock 26 is shown with a spaced apart array of bases 16 mounted spaced apart around the outer perimeter 26a of the dock. Bases 16 are pre-positioned and rigidly mounted in place by for example bolting of mounting bracket 16b to the valance side boards 26b of dock 26. Mounting bracket 16b may be mounted to side boards 26b for example by the use of fasteners such as bolts mounted through holes 16c in mounting bracket 16b. In preferred embodiments, the mounting bracket includes a metal plate which may for example have dimensions of approximately 4 inches by 6 inches although this in not intended to be limiting and would be made smaller or larger depending on the size of the sideboards 26b and the length of collar 16a. Collar 16a may for example have a vertical height in the range of 2-6 inches. Collar 16a may for example be 2 inches in diameter. Sleeve 18 is of longer length than collar 16a and may for example be 18 inches in overall length as measured vertically when the sleeve 18 is mounted in collar 16a. For example, the receiver 18a portion of sleeve 18 may be approximately 12 inches long. Male mating portion 18b, below receiver 18a, may be approximately 6 inches long. The diameter of receiver 18a may match the diameter of collar 16a so that one is flush with the other. The diameter of male mating portion 18b may be tapered or of a uniform smaller diameter, for example 1 and ⅝ inches, so as to snugly fit into the interior cylindrical cavity of collar 16a. Collar 16a may be mounted to mounting bracket 16b as for example by welds 16d. The uppermost edges 16e of bases 16 may advantageously be coplanar so that when bases 16 are mounted onto dock 26 they are substantially coplanar with a horizontal plane A containing the upper surface of dock 26, or are recessed there-under so that the upper edges 16e do not protrude above plane A to avoid providing a vertically protruding obstacle on which users might trip or stub their toes. An aperture, or oppositely disposed pair of apertures 18d and 16f may be provided in the lowermost ends of male mating portion 18b and collar 16a respectively A pin (not shown) may be provided to releasably lock sleeve 18 into collar 16a.

With bases 16 so mounted around perimeter 26a one or more umbrellas 14 may be selectively located by mounting of their corresponding poles 12, with their lower ends encased in sleeves 19 into sleeves 18 mounted in the appropriate bases 16 so as to cast the shadow penumbra 32 corresponding to each umbrella sun-shade 24 onto the upper surface of dock 26.

Thus in the example given in FIG. 5, which is intended merely to be a representative example and not intended to be limiting, during the summer months, the sun 34 may in the early morning be shining substantially in direction B so as to cast a shadow penumbra 32 when an umbrella 14 is mounted in the base 16 at position B′. Thus if a user desires shade on dock 26 in the early morning, umbrella 14 is mounted into base 16 at position B′ thereby providing a user with the full shadow penumbra 32 on the area of dock 26 adjacent to position B′ when looking in direction B. As the day progress and the sun 34 traverses the sky as diagrammatically shown in FIG. 5, the direction of the sunlight will alter accordingly and the shadow penumbra 32 cast adjacent position B′ will rotate so that in the example of FIG. 5 the shadow begins to fall over the body of water 28. By high noon, when sun 34 is shining in direction C, penumbra 32 will be almost completely over body of water 28, rendering that position useless for a user seeking shade on dock 26. Thus as the day progresses towards high noon, a user may then select from one of bases 16 in position C′ so as to then locate the corresponding shadow penumbra 32 in a position along dock 26 as may be desired. With one or more umbrellas 14 mounted in bases 16 in positions C′, the user will enjoy shade in shadow penumbra 32 during the time period on either side of, and at high noon. As the afternoon progresses the shadow penumbras 32 associated with position C′ rotate and again gradually fall onto body of water 28 rather than onto dock 26. Thus for the mid-to-late afternoon, when the sunlight is shining in direction D, the user may move one or more umbrellas 14 and mount them into bases 16 at positions D′ so as to thereby cast shadow penumbras 32 once again completely onto dock 26 so that the user may enjoy shade in those positions. To provide shade in the evening, when sunlight is shining in direction E, bases 16 may be positioned at positions E′.

Thus for any particular platform, a user may simply locate and install a series of bases. 16 at positions which the user finds advantageous to cast shadows onto the platform from umbrellas 14 at desired times of the day. Thus for example if a user desires shade in order to eat a meal, whether it be breakfast, lunch or dinner, the user may position corresponding bases 16 so as to provide full shade onto the platform at the corresponding times of day during the hottest season of the year. Once the positions of bases 16 are set for first time-of-day, further bases may be added as needed to provide full shade during for example the mid afternoon when the user desires to sunbathe. In the case of where the platform is a dock such as dock 26, the positioning of bases 16 may be tempered by the need to use a particular side of the dock to moor a vessel such as a boat, in which case then bases 16 may not be mounted in those positions to avoid interfering with or rubbing against the side of the boat. Alternatively, bases 16 may be encased in resilient padding in order to avoid damage to a boat.

Once the series of bases 16 are mounted around the perimeter of the platform, for example are mounted around perimeter 26a of dock 26, a user may merely follow a preset sequence of timed repositioning of one or more umbrellas 14 knowing that the positioning of umbrellas 14 according to a pre-selected roughly timed sequence will provide for a useful amount of shade during pre-selected time slots during the day. This procedure may, where enough bases 16 are employed, provide useful shade throughout the day as one or more umbrellas 14 are moved along the series of bases 16 provided in spaced apart array around perimeter 26a.

Again depending on the number of bases 16 which a user desires to employ, the spacing between adjacent bases 16 may be substantially equal to or slightly more than the diameter of a fully open sun shade 24 so that with a pair of umbrellas 14 mounted in adjacent bases 16, firstly, the adjacent sun shades 24 will not interfere with one another when fully opened, and secondly, the adjacent shadow penumbras 32 will collectively provide a more or less continuous patch of useful shade.

There is a further consideration in the mounting of umbrellas onto platforms which may be subjected to wind gusts as for example experienced by applicant on applicant's dock where unexpected wind gusts may come in off the water while the sun shade on the umbrellas are fully open and before a user can react to close the sun shades and secure them closed. In applicant's opinion it is often more desirable beyond a certain wind force to allow an umbrella 14 to lift clear of the dock rather than have the wind gusts damage the sun shade on the umbrella. Thus in the present invention, either the fasteners 20a holding the sleeve 19, which holds umbrella pole 12, into sleeve 18 may be set at only a relatively light frictional engagement against sleeve 19 so that given a significant wind gust the pole and sleeve 19 will lift upwardly completely out of sleeve 18, or alternatively, the fitting of male mating portion 18b into collar 16a may be sufficiently loose and not pinned to collar 16a, or sufficiently telescopically slidable so that, with the umbrella pole 12 securely fastened into sleeve 19 and sleeve 19 securely fastened into receiver 18a, a wind gust will merely lift the umbrella, sleeve 19, and sleeve 18 upwardly as a whole so as to clear corresponding base 16.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for supporting an umbrella pole on a sunning platform comprising the steps of:
a) providing a plurality of pole supports each having a base and sleeves, wherein each said sleeve has opposite upper and lower ends, and wherein said second sleeve is adapted for mounting a length of pole therein so that the length of pole extends between said upper and lower ends of said second sleeve, and wherein said second sleeve telescopically mounts snugly nested with said first sleeve, and wherein said lower end of said first sleeve is adapted for removable mounting in said base,
b) mounting said base of said each pole support to the platform:
i) so that an upper-most surface of each said base is at or beneath an elevation of an upper surface of the platform and so that said sleeves are substantially vertical when mounted to said base,
ii) around at least a perimeter of the platform so as to be spaced apart in a spaced apart array of said supports along at least a first side of the platform closest to the sun at a first pre-selected time of day.

2. The method of claim 1 wherein each umbrella casts a shadow and wherein each said shadow has orthogonally oriented first and second dimensions lying in a plane of the platform, and wherein when the sun is directly overhead of the platform the first and second dimensions are substantially equal, and wherein said first dimensions are substantially parallel to said first side of said platform, and wherein said spaced apart array of said pole supports mounted along said first side of said platform are spaced apart by a first spacing, and wherein said first spacing is substantially equal to said first dimension at said pre-selected time of day, wherein, at said first pre-selected time of day, a pair of substantially identical umbrellas when fully open and mounted in an adjacent pair of said pole supports produce corresponding adjacent shadows which: a) substantially cover said first spacing therebetween; and, b) fall substantially completely on said platform when said second dimension does not exceed a corresponding dimension of the platform.

3. The method of claim 2 further comprising mounting at least one further pole support of said plurality of pole supports along a second side of said platform closest to the sun at a second pre-selected time of day, wherein, at said second preselected time of day, an umbrella when fully open and mounted in said at least one further pole support casts a shadow which falls substantially completely on said platform.

4. The method of claim 3 wherein said at least one further pole support is a plurality of further pole supports, and wherein said plurality of further pole supports are mounted spaced apart along said second side of said platform so that adjacent substantially identical umbrellas when fully open and mounted thereto cast shadows which:
a) substantially cover a corresponding spacing between adjacent pole supports of said plurality of further pole supports; and
b) fall substantially completely on said platform when said second dimension of the shadows does not exceed a corresponding dimension of said platform.

5. The method of claim 4 wherein, collectively, said plurality of pole supports are mounted spaced apart around a perimeter of said platform so that shadows cast by at least one umbrella, mounted in corresponding said pole supports on a pre-selected side of said platform which is closest to the sun at a corresponding pre-selected time of day, fall substantially completely on said platform.

6. The method of claim 5 wherein said corresponding pre-selected time of day forms part of a sequence of pre-selected times of day which correspond to a sequence of positions of said plurality of pole supports around said perimeter of said platform, wherein following said sequence of positions by mounting said at least one umbrella in positions in said sequence of positions according said corresponding sequence of pre-selected times of day results in said shadows of said at least one umbrellas falling substantially completely on a corresponding portion of said platform, substantially throughout said sequence of pre-selected times of day, whereby at any one time of said pre-selected times of day one said shadow falls on said platform to provide shade for a user on said platform.

7. The method of claim 6 wherein said each first sleeve includes a hollow receiver having an open top end and an opposite bottom end, said receiver sized to receive said lower end of a corresponding said second sleeve journalled therein, and wherein said each base includes a mounting bracket to mount each said base to a rigid surface so as to position said receiver vertically with said open top end substantially directly above said bottom end, and wherein said method further includes the step of mounting said mounting brackets to said platform at said sequence of positions.

8. The method of claim 7 wherein said base mounts to said bottom end of said receiver in male/female mating engagement therebetween.

9. The method of claim 8 wherein said each base includes a collar, and wherein said receiver is elongate and upstanding when mounted to said base, and sized to snugly mate down into said collar, and wherein said second sleeve is adapted to contain and support therein a corresponding length of a lower end of an umbrella pole.

10. A system for supporting an umbrella pole on a sunning platform comprising: a plurality of pole supports each having a base and at least one sleeve, each sleeve of said at least one said sleeve having opposite upper and lower ends, wherein said each sleeve is adapted for mounting a length of pole therein so that the length of pole extends between said upper and lower ends of said each sleeve, and wherein said lower end is adapted for removable mounting in said base, wherein each said base of said each pole support is adapted for mounting to the platform:
a) so that an upper-most surface of each said base is at or beneath an elevation of an upper surface of the platform and so that said sleeve is substantially vertical when mounted to said base; and,
b) around at least a perimeter of the platform so as to be spaced apart in a spaced apart array of said supports along at least a first side of the platform closest to the sun at a first pre-selected time of day.

11. The system of claim 10 wherein once so mounted, on a sunny day each umbrella casts a shadow, and wherein each said shadow has orthogonally oriented first and second dimensions lying in a plane of the platform, and wherein when the sun is directly overhead of the platform the first and second dimensions are substantially equal, and wherein said first dimensions are substantially parallel to said first side of said platform, and wherein said spaced apart array of said pole supports are mountable along said first side of said platform spaced apart by a first spacing which is substantially equal to said first dimension at said pre-selected time of day, whereby at said first pre-selected time of day a pair of substantially identical umbrellas when fully open and mounted in an adjacent pair of said pole supports produce corresponding adjacent shadows which: a) substantially cover said first spacing therebetween; and, b) fall substantially completely on said platform when said second dimension does not exceed a corresponding dimension of the platform.

12. The system of claim 11 wherein at least one further pole support of said plurality of pole supports is adapted for mounting along a second side of said platform closest to the sun at a second pre-selected time of day, whereby at said second pre-selected time of day and umbrella when fully open and mounted in said at least one further pole support casts a shadow which falls substantially on said platform.

13. The system of claim 12 wherein said at least one further pole support is a plurality of further pole supports, and wherein said plurality of further pole supports are adapted for mounting spaced apart along said second side of said platform so that adjacent substantially identical umbrellas when fully open and mounted thereto cast shadows which:
a) substantially cover a corresponding spacing between adjacent pole supports of said plurality of further pole supports; and
b) fall substantially completely on said platform when said second dimension of the shadows does not exceed a corresponding dimension of said platform.

14. The system of claim 13 wherein, collectively, said plurality of pole supports are adapted for mounting spaced apart around a perimeter of said platform so that shadows cast by at least one umbrella, when mounted in corresponding said pole supports on a pre-selected side of said platform which is closest to the sun at a corresponding pre-selected time of day, fall substantially completely on said platform.

15. The system of claim 14 adapted so that said corresponding pre-selected time of day forms part of a sequence of pre-selected times of day which correspond to a sequence of positions of said plurality of pole supports around said perimeter of said platform, wherein following said sequence of positions by mounting said at least one umbrella in positions in said sequence of positions according said corresponding sequence of pre-selected times of day results in said shadows of said at least one umbrellas falling substantially completely on a corresponding portion of said platform, substantially throughout said sequence of pre-selected times of day, whereby at any one time of said pre-selected times of day one said shadow falls on said platform to provide shade for a user on said platform.

16. The system of claim 15 wherein said each sleeve includes a hollow receiver having an open top end and an opposite bottom end, said receiver sized to receive an umbrella pole journalled therein, and wherein said each base includes a mounting bracket to mount each said base to a rigid surface so as to position said receiver vertically with said open top end substantially directly above said bottom end.

17. The system of claim 16 wherein said base mounts to said bottom end of said receiver in male/female mating engagement therebetween.

18. The system of claim 17 wherein said each base includes a collar, and wherein said receiver is elongate and upstanding when mounted to said base, and sized to snugly mate down into said collar, and wherein said receiver is adapted to contain and support therein a corresponding length of a lower end of an umbrella pole.
